(19) United States
(12) Patent Application Publication
(10) Pub. No.: US 2017/0186083 A1
(43) Pub. Date: Jun. 29, 2017

(54) DATA MINING A TRANSACTION HISTORY DATA STRUCTURE

(71) Applicant: PAYPAL, INC., San Jose, CA (US)

(72) Inventors: Hui-Min Chen, San Jose, CA (US); Lian Liu, San Jose, CA (US)

(21) Appl. No.: 14/982,170

(22) Filed: Dec. 29, 2015

Related U.S. Application Data
(60) Provisional application No. 62/264,282, filed on Dec. 7, 2015.

(51) Int. Cl. G06Q 40/02; G06F 17/30

(52) U.S. Cl. CPC G06Q 40/02; G06F 17/30592; G06F 17/30539; G06F 17/30598

(57) ABSTRACT

Systems, methods, and computer program products are disclosed for performing data mining of transaction history data. The transaction history data is stored in at least one data store. Categories are extracted from the transaction history. The categories are associated with bins that represent payment amount ranges of the categories. Topic vectors are generated that map topics to the bins. Based on the topic vectors, customer vectors are generated that map customers to the topics. Based on the customer vectors, the customers are classified into one or more classifications.

### CROSS REFERENCE TO RELATED APPLICATION

Pursuant to 35 U.S.C. §119(e), this application claims priority to the filing date of U.S. Provisional Patent Application Ser. No. 62/264,282, filed Dec. 7, 2015, which is incorporated by reference in its entirety.

### BACKGROUND

### Field of the Invention

The present disclosure generally relates to data mining, and more particularly to data mining transaction history data from a data warehouse.

### Related Art

Data mining is a field of computer science that relates to extracting patterns and other knowledge from large amounts of data. One source of this data is transaction history data that includes logs corresponding to electronic transactions. Transaction history data may be stored in large storage repositories, which may be referred to as data warehouses or data stores. These storage repositories may include vast quantities of transaction history data.

Traditionally, data mining of transaction history data has been useful to provide valuable insight into product improvement, marketing, customer segmentation, fraud detection, and risk management. For example, transaction volume and amount data for customers may be extracted from transaction history data and analyzed to provide useful insights into customer credit risk.

However, while conventional data mining techniques have been generally adequate for extracting and analyzing transaction data, limitations remain. For example, conventional data mining techniques do not fully capture each customer's credit risk. Inaccurate classifications of customers based on analysis provided by conventional data mining techniques may result in defaults that harm merchants and other businesses. Accordingly, a need exists for improving accuracy of the insights provided by data mining. Thus, data mining techniques that more accurately analyze transaction history data would provide numerous advantages in fields such as product improvement, marketing, customer segmentation, fraud detection, and risk management.

### BRIEF DESCRIPTION OF THE DRAWINGS

The present invention is illustrated by way of example and not limitation in the figures of the accompanying drawings.

FIG. 1 is a block diagram illustrating a system architecture for data mining a transaction history data structure, in accordance with various examples of the present disclosure.

FIG. 2 is a block diagram illustrating a computer system suitable for implementing one or more devices of the computing system in FIG. 1.

FIG. 3 is a flow diagram illustrating data mining of a transaction history data structure, in accordance with various examples of the present disclosure.

FIG. 4 is a block diagram illustrating a data structure for associating payment amount ranges with a bin, in accordance with various examples of the present disclosure.

FIGS. 5A and 5B are block diagrams illustrating data structures for mapping topics to bins, in accordance with various examples of the present disclosure.

FIG. 6 is a block diagram illustrating a data structure for mapping customers to topics, in accordance with various examples of the present disclosure.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Various embodiments provide a system, method and machine-readable medium for parsing transaction history data from one or more data stores. The transaction history data includes data corresponding to purchases, such as category and payment amount data. The transaction history data is parsed and analyzed to provide additional insight into fields such as product improvement, marketing, customer segmentation, fraud detection, and risk management. As an example, the present disclosure describes classifying customers into credit risk classifications based on categories of items purchased and purchase prices corresponding to those items.

To classify the customers based on the category and purchase price information, a number of bins are prepared for each category. This may be performed by parsing category and payment amount data from transaction history data for a particular time window. From these categories and payment amounts, a plurality of bins are created for each category. Each bin corresponds to a purchase price range of a category. For example, a first bin may correspond to items in a category that have a first purchase price range. A second bin may correspond to items in the category that have a second purchase price range. Accordingly, there are a number of bins that are prepared for each of the categories.

Next, a topic model is trained. The topic model may be trained by correlating the bins to particular topics. In some examples, an amount of topics are predefined by one or more users. Correlating may include, for example, determining a probability distribution for the bins over each topic. The correlating may include performing techniques such as Variational Expectation-Maximization (VEM), Gibbs sampling, Simulated Annealing, and Latent Dirichlet Allocation (LDA). Accordingly, a topic model is trained that groups highly correlated bins into topics.

After training the topic model, the topic model is used to correlate particular customers with the topics. This technique may include extracting information corresponding to the customers from the transaction history data. For example, categories of items purchased by the customers and the payment amounts corresponding to the purchases may be extracted. This information may be input into the topic model to correlate the customers to topics, based on the items purchased by the customers and the purchase prices of the items.

The correlation of the customers to the topics is useful for gaining additional insight into fields such as product improvement, marketing, customer segmentation, fraud detection, and risk management. For example, customers that are highly correlated with particular topics may be determined to be correlated with a particular credit risk. These correlations provide valuable insight and may be advantageously used to classify customers. In some examples, customer segmentation, cluster analysis, credit risk scoring, and so forth are useful applications of the present disclosure. Of course, it is understood that these features and advantages are shared among the various examples herein and that no one feature or advantage is required for any particular embodiment.

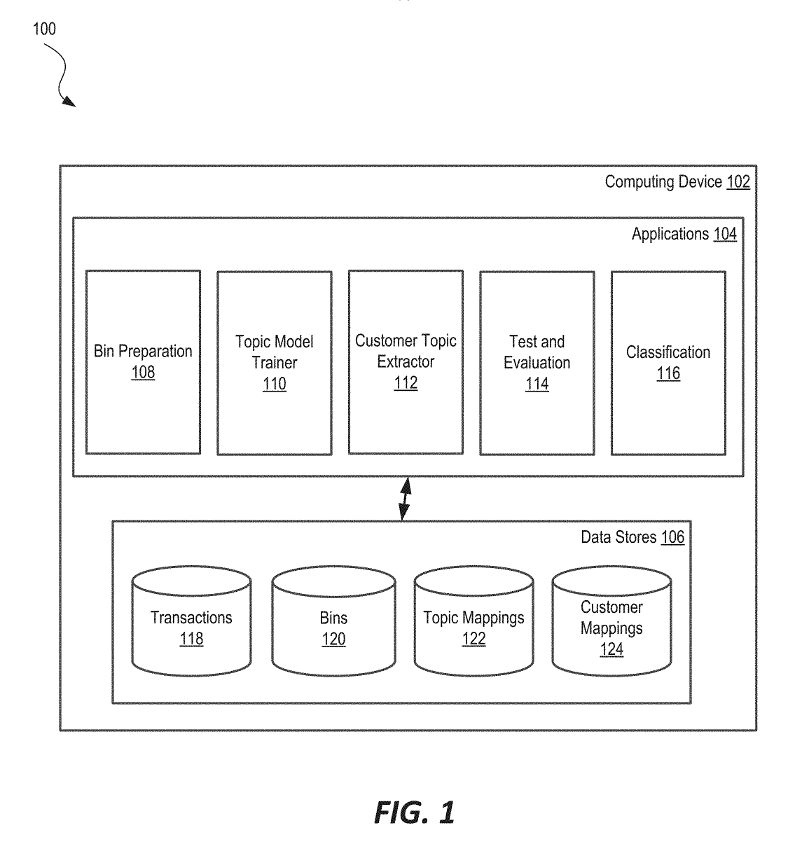

FIG. 1 illustrates a system architecture 100 for data mining a transaction history data structure, in accordance with various examples of the present disclosure.

The system architecture 100 includes at least one computing device 102 that may be adapted to implement one or more of the processes for performing data mining as discussed herein. In some examples, the computing device 102 is structured as rack mount server, desktop computer, laptop computer, or other computing device. The computing device 102 may also include one or more computing devices that are communicatively coupled, such as via a network.

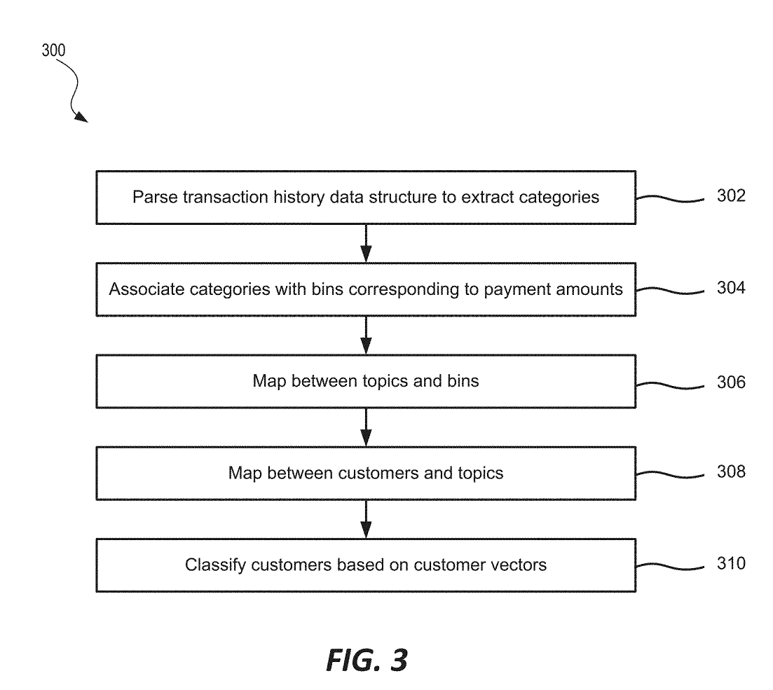

The computing device 102 includes one or more applications 104. The applications 104 are structured to include computer-readable and executable instructions to perform operations, such as those described with respect to FIG. 3. The applications 104 may be structured as one or more applications. For example, some or all of the applications 104 illustrated may be combined into a single application. In another example, one or more of the applications 104 may be split into a plurality of applications. The applications 104 may run on top of an operating system, such as being loaded by an operating system loader, and executed by one or more processes created by the operating system. In some examples, the applications 104 are structured to display graphical user interfaces (GUIs) to present information to and/or receive information from one or more users.

In the present example, the applications 104 include a bin preparation application 108, a topic model trainer application 110, a customer topic extractor application 112, a test and evaluation application 114 and a classification application 116. In other examples, the applications 104 may be structured as one or more applications that may be stored and executed on one or more computing devices.

The data stores 106 are structured to store data that is accessible to (e.g., readable and/or writable by) the applications 104. The data stores 106 may be referred to as a data warehouse. In the present example, the data stores 106 are structured to include data that is queried, collected, parsed, modified, and/or written by the applications 104. In some examples, one or more of the data stores 106 include a relational database, XML database, flat file, and/or any other data store that is structured to store data. In other examples, one or more of the data stores 106 may be provided by a web service that is accessed via a network to perform Input/Output (I/O) operations. The data stores 106 may be homogenous or heterogeneous (e.g., one or more of the data stores 106 may be structured as a relational database and one or more other data stores 106 may be structured as an XML database or other database type).

In the present example, the data in the data stores 106 relates to prior transactions that were performed, such as purchases of items by one or more customers from one or more merchants. This prior transactions data may be referred to as transaction history data or transactions data.

In the present example, the transactions data store 118 is structured to store transaction history data. The transaction history data stored in the transactions data store 118 may include one or more transaction records that each represent a purchase of an item by a customer. Each transaction record may be identified by a unique transaction identifier and may include information corresponding to the transaction, such as an identifier of the product(s) purchased, a payment amount corresponding to the product(s), a unique customer/purchaser identifier, a unique seller/merchant identifier, and a category associated with the product or seller, such as a product category or a seller industry category.

Examples of categories may include, for example, computer hardware, cellphones, gaming, auto parts, camera, food and drink, electronics, tickets, fashion, music, travel, pet supplies, jewelry, arts and craft, garden, and so forth. These are merely some examples of categories that may be configured. In other examples, there may be other categories that are configured that are different than these categories.

In some examples, the transactions data store 118 is structured as a relational database that includes the transaction identifier as the primary key. The transaction identifier may uniquely identify the data corresponding to the transaction (e.g., customer identifier, product identifier, category, payment amount, and so forth). In some examples, the transactions data corresponding to a transaction identifier is structured in a row of the database, and may be referred to as a tuple. Accordingly, the transactions data store 118 provides at least one data structure that stores a transaction history. While the transaction history data structure is described as a database in this example, in other examples other data structures may be used to store transaction history data.

In the present example, the bin preparation application 108 is structured to perform data mining of transactions data store 118 to extract transactions data from the transactions data store 118.

In some examples, the bin preparation application 108 is structured to data mine the transactions data store 118 by extracting the transactions data, such as the category and payment amount corresponding to each transaction record. An example data mining process that may be performed by the bin preparation application 108 is described in further detail with respect to FIG. 3.

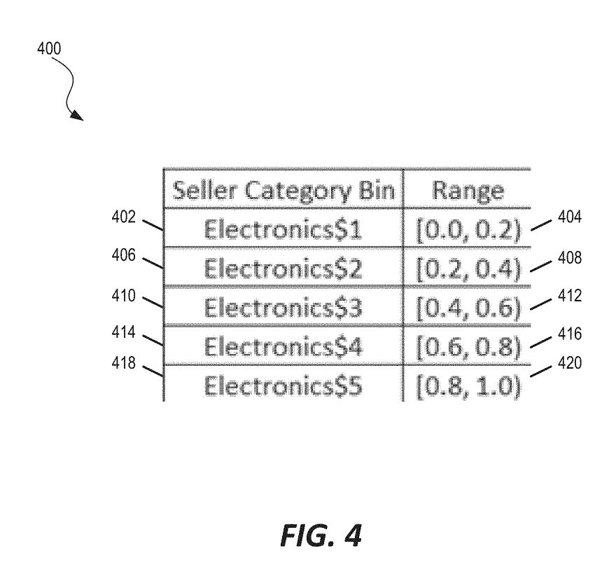

The bin preparation application 108 is structured to create bins corresponding to each extracted category. The bin preparation application 108 is structured to associate a payment amount range with each created bin, and store the associations in the bins data store 120. In some examples, the bins data store 120 is structured as a relational database that stores an association between each bin and a payment amount range. An example of a database data structure that includes the bins and the associated payment amount ranges is described with respect to FIG. 4.

The topic model trainer application 110 is structured to access the bins data store 120 to extract the bins and associate topics with the bins. In some examples, the number of topics is selected based on a user-configured value. In some examples, the topics are associated with the bins by defining the topics as a probability distribution over the bins. An example of defining the topics as a probability distribution over the bins is described in further detail with respect to FIG. 3. In some examples, the topic model trainer application 110 is structured to extract transactions data for a subset of customers from the transactions data store 118, where the transactions data corresponds to a particular time window (e.g., such as the most recent twelve months).

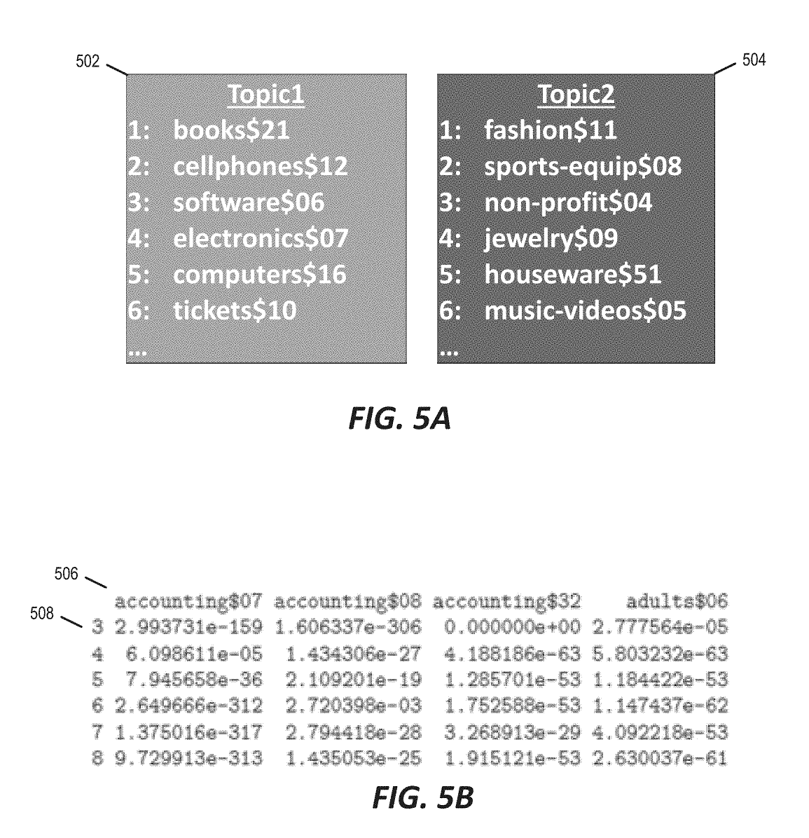

The topic model trainer application 110 is structured to generate one or more topic mapping data structures that map between topics and the bins, based on the collected transactions data. An example of a topic mapping structure is described with respect to FIGS. 5A and 5B. The topic mapping may be structured as one or more tables, matrices, vectors, and/or tuples. For example, the mapping may include a topic vector that includes a vector element corresponding to each of the bins. Each vector element may be structured to include a probability distribution of the topic for a particular bin. The topic vector elements may be normalized, such that the sum of the topic vector elements is equal to one. The topic model trainer application 110 stores the topic mappings in the topic mappings data store 122.

The topic mappings data store 122 is structured to store mappings between topics and bins. In some examples, these mappings are stored in one or more data tables of a relational database, such that the probability distribution of each topic over the bins is structured as a row of a database table. The rows may be indexed by the topics and the columns may be indexed by the bins. Accordingly, each element in the table may represent a probability of a particular topic over a particular bin. In other words, each row may be a probability distribution corresponding to a topic. Accordingly, a relational database may be structured to map the topics to the bins. In other examples, the topic mappings may be stored in a matrix format, which may be provided by a two-dimensional array or other data structure.

The customer topic extractor application 112 is structured to access the topic mappings data store 122 to extract the mappings between the topics and bins. In the present example, the customer topic extractor 112 is also structured to extract customer identifiers from the transactions data store 106 and transactions data associated with the customers. In some examples, the transactions data that is extracted corresponding to each customer is limited to a time window (e.g., twelve months). The customer topic extractor application 112 is structured to define one or more customers as a probability distribution over the topics, using the topic and bin mappings. An example of defining the customers as a probability distribution over the topics is described in further detail with respect to FIG. 3.

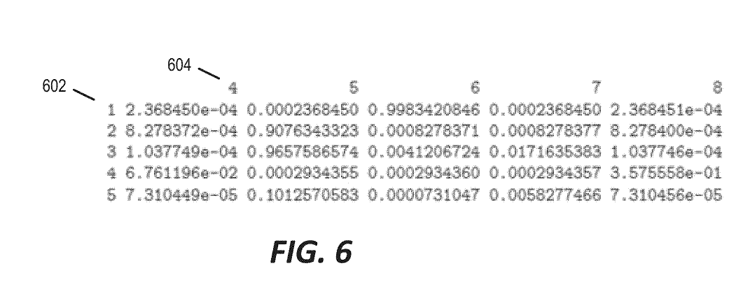

The customer topic extractor application 110 is structured to generate one or more customer mapping data structures that map between customers and the topics, based on the collected customer data and the topic and bin mappings. An example of a mapping structure for the customers and topics is described with respect to FIG. 6. In some examples, the customer mapping is structured as one or more tables, matrices, vectors, and/or tuples. For example, the mapping may include a customer vector that includes a vector element corresponding to each of the topics. Each vector element may be structured to include a probability of the customer for a particular topic. In some examples, the customer vector elements are normalized, such that the sum of the customer vector elements is equal to one. The topic model trainer application 110 stores the customer mappings in the customer mappings data store 124.

The customer mappings data store 124 is structured to store mappings between customers and topics. In some examples, these mappings are stored in one or more data tables of a relational database, such that the probability distribution of each customer over the topics is structured as a row of a database table, with each column of the row including a probability of the customer corresponding to a particular topic. The rows may be indexed by customers and the columns may be indexed by the topics. Accordingly, each element in the table may represent a probability of a particular customer over a particular topic. Accordingly, a relational database may be structured to map the customers to the topics. In other examples, the customer mappings may be stored in a matrix format, which may be provided by a two-dimensional array or other data structure.

The test and evaluation application 114 is structured to extract the mappings between the customer and topics from the customer mappings data store 124 and correlate the customer vectors with data such as customer segmentation data, fraud detection data, credit risk management data, and so forth. For example, the test and evaluation application 114 may correlate the customer mappings 124 with credit data such as customer credit scores that are retrieved from one or more credit bureaus.

In some examples, topics and bins may be redefined and the customer topic mappings updated based on the redefined topics and bins. For example, topics may be redefined by specifying a different set of topics. For example, the bins may be redefined by specifying a different number of bins to associate with the categories. Based on the redefined topics and/or bins, new customer mappings may be generated. The test and evaluation application 114 may be re-run to correlate the updated customer mappings to identify the correlation between the updated customer mappings and the customer credit scores. The analysis of the test and evaluation application 114 may be used to optimize the defining of the topics and bins to determine customer mappings that have an optimal correlation with the customer credit scores. In other examples, other customer segmentation data, fraud detection data, credit risk data, or other data may be processed by the test and evaluation application 114 instead of or in addition to the customer credit scores.

Once a topic and/or bin definition is determined by the test and evaluation application 114, the classification application 116 is structured to extract the mappings between the customer and topics from the customer mappings data store 124 and classify the customers into categories and/or sets based on the mappings. For example, the test and evaluation application 114 may identify that customers that have a higher probability distribution with respect to particular topics are correlated with particular credit scores. Accordingly, those customers may be classified as having a particular credit risk. In other examples, the classification application 116 is structured to classify the customers into other classifications based on the mappings. An example of classifying the customers is described in further detail with respect to FIG. 3.

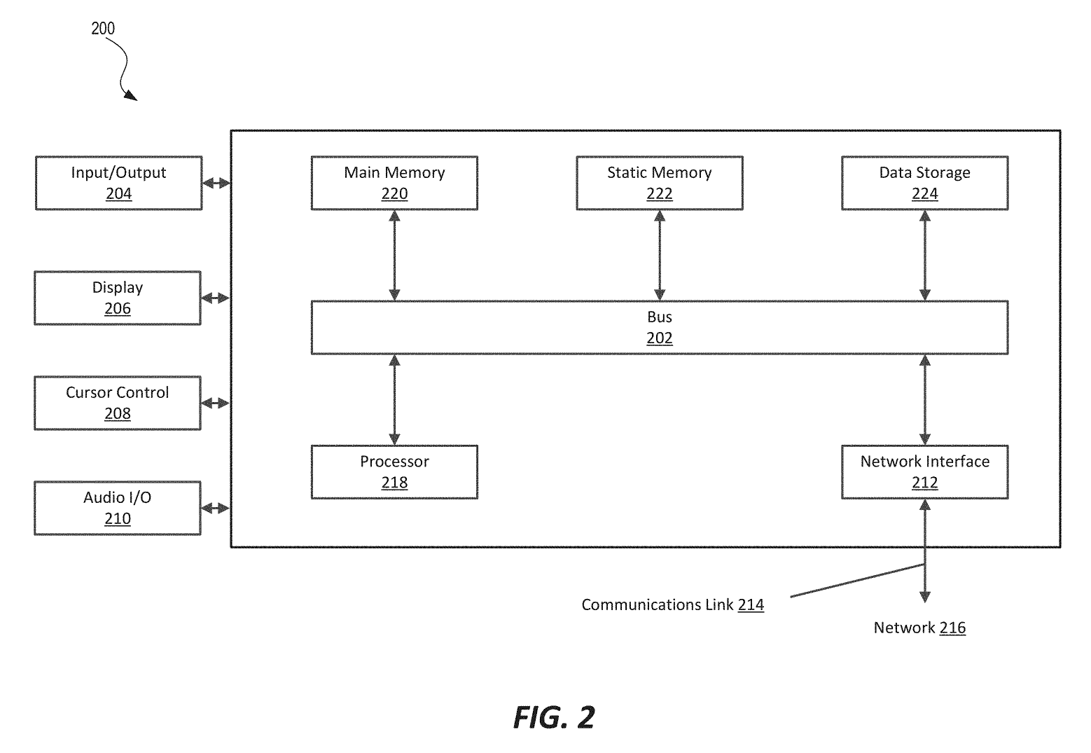

FIG. 2 illustrates an exemplary computer system 200 in block diagram format suitable for implementing on one or more devices of the computing system in FIG. 1. In various implementations, computer system 200 may comprise a computing device, such as a smart or mobile phone, a computing tablet, a desktop computer, laptop, wearable device, rack mount server, and so forth.

Computer system 200 may include a bus 202 or other communication mechanisms for communicating information data, signals, and information between various components of computer system 200. Components include an I/O component 204 that processes a user action, such as selecting keys from a keypad/keyboard, selecting one or more buttons, links, actuatable elements, etc., and sends a corresponding signal to bus 202. I/O component 204 may also include an output component, such as a display 206 and a cursor control 208 (such as a keyboard, keypad, mouse, touch screen, etc.). An optional audio I/O component 210 may also be included to allow a user to hear audio and/or use voice for inputting information by converting audio signals.

A network interface 212 transmits and receives signals between computer system 200 and other devices, such as user devices, data storage servers, payment provider servers, and/or other computing devices via a communications link 214 and a network 216 (e.g., such as a LAN, WLAN, PTSN, and/or various other wired or wireless networks, including telecommunications, mobile, and cellular phone networks).

The processor 218 represents one or more general-purpose processing devices such as a microprocessor, central processing unit, or the like. More particularly, processor 218 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 108 may also be one or more special-purpose processing devices such as an application specific integrated circuit (ASIC), a field programmable gate array (FPGA), a digital signal processor (DSP), network processor, or the like. Processor 218 is configured to execute instructions for performing the operations and steps discussed herein.

Components of computer system 200 also include a main memory 220 (e.g., read-only memory (ROM), flash memory, dynamic random access memory (DRAM) such as synchronous DRAM (SDRAM), double data rate (DDR SDRAM), or DRAM (RDRAM), and so forth), a static memory 222 (e.g., flash memory, static random access memory (SRAM), and so forth), and a data storage device 224 (e.g., a disk drive).

Computer system 200 performs specific operations by processor 218 and other components by executing one or more sequences of instructions contained in main memory 220. Logic may be encoded in a computer readable medium, which may refer to any medium that participates in providing instructions to processor 218 for execution. Such a medium may take many forms, including but not limited to, non-volatile media, volatile media, and/or transmission media. In various implementations, non-volatile media includes optical or magnetic disks, volatile media includes dynamic memory, such as main memory 220, and transmission media between the components includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 214 to the network 216 may perform instruction sequences to practice the present disclosure in coordination with one another. Modules described herein may be embodied in one or more computer readable media or be in communication with one or more processors to execute or process the steps described herein.

FIG. 3 illustrates data mining of a transaction history data structure, in accordance with various examples of the present disclosure. In some examples, the method 300 is implemented by one or more processors of one or more of the system architecture 100, by executing computer-readable instructions to perform the functions described herein. It is understood that additional steps can be provided before, during, and after the steps of method 300, and that some of the steps described can be replaced or eliminated in other examples of the method 300.

At action 302, a computing device parses transaction records from one or more transaction history data structures and extracts category information from the transaction history data structures. In the present example, each transaction record represents a purchase made by a customer for a particular product. In some examples, the data that is extracted from the transaction history data structure(s) includes customers, items purchased by the customers, categories corresponding to the items, and payment amounts of the items. Categories that are extracted may include seller industry categories and/or product categories that are assigned to each transaction record to describe the items that were purchased in the transaction.

In some examples, a time window is pre-defined or user-configured, such that the data collected is for a particular time window. For example, a time window may be set to the most recent twelve months to exclude data from being collected prior to the twelve-month period. In other examples, other time windows may be set.

At action 304, for each category, a number of bins are created to further sub-divide the category. These bins are associated with payment amount ranges, such that items in the category are further categorized into the bins.

In some examples, the number of bins is selected based on a user-configured value. In some examples, the number of bins is between 10 and 100 bins. For each category, the payment amounts of items in the category are extracted from the transaction history data structure(s) to determine a minimum payment amount corresponding to the least expensive item in the category, a maximum payment amount corresponding to the most expensive item in the category, and an average payment amount of all of the items in the category.

In the present example, the payment amounts corresponding to the items in each category are normalized to normalized payment amounts. In some examples, the normalizing is performed by transforming each payment amount to a Z-scaled payment amount that is between 0 and 1 using the following formula:

Z-scaled payment amount=(payment amount−MIN)/(MAX−MIN); (1)

where MIN is the minimum payment amount in the category and MAX is the maximum payment amount in the category.

Each bin in each category is assigned a payment amount range, such that items in the category that are within that purchase price range are categorized into the bin. In some examples, the range of the i^{th} bin (i: 1, . . . , M) is determined as follows:

Lower bound=(i−1)*1.0/M

Upper bound=(i)*1.0/M; (2)

where i is the particular bin in the category, and M is the total number of bins in the category.

An example of a database table data structure that includes the bins and the payment amount ranges corresponding to the bins is described with respect to FIG. 4.

The total number of bins that are created for the categories is N, where N=(number of bins per category)*(number of categories). As previously discussed, the number of bins per category may be user defined, and the number of categories may be determined based on a number of categories that are extracted from the transaction history data structure(s). For example, if five categories are extracted from the transaction history data structure(s), then the number of categories may be set to five.

At action 306, the computing device maps between topics and the bins that were created for the categories. In some examples, the topics are defined by one or more users. The bins are correlated to the topics by determining a probability distribution of each topic over the category bins. In the present example, the probability distribution may be represented by a matrix that is structured as including a topic in each row and a bin in each column, such that a particular topic row of the matrix represents the probability distribution of the particular topic over the bins. This matrix may be referred to as a mapping between bins and topics, and may be generated from the Latent Dirichlet Allocation (LDA) model. There are several algorithms that may be used to determine the values for the matrix, such as the Variational Expectation-Maximization (VEM) algorithm or Gibbs sampling. In other examples, other probability distribution algorithms may also be used.

In the present example, a sample of customer accounts are data mined from the transaction history data structure(s). The sample may include a user configured number of customer accounts and the data obtained corresponding to the customer accounts may be from a time window, such as a most recent twelve months.

For the sampled customer accounts, a customer—bin matrix may be created to map between the customer and the bins. The matrix may be referred to as a corpus. In this example, the matrix includes rows indexed by customers and columns that are indexed by bins. For example, the entries in a particular row correspond to a particular customer, and the entries in each column of the row correspond to a number of items that the particular customer has purchased that are associated with a bin.

In some examples, the matrix is structured as a two-dimensional array. The matrix may be a sparse matrix (i.e. containing a lot of zeroes), because each customer may buy items from only a few number of category bins. Accordingly, in some examples, the matrix may be compressed to a sparse representation of the matrix to preserve memory space.

The topics and the matrix may be input into the probability distribution algorithm (e.g., VEM), which matches the topics to the bins. For example, if the VEM algorithm is used, the VEM algorithm will determine the topic—bin matrix by maximizing a likelihood function, such as:

β=arg max_{β} Pr[D|β]; (3)

where β is the topic—bin matrix, and D is the input customer—bin matrix.

The output of the probability distribution algorithm is the topic—bin matrix that maps between the topics and bins. This matrix may be stored in a database table data structure.

An example of a database table data structure that includes the topics as rows of the database table and the bins as columns of the database table is described with respect to FIG. 5B. FIG. 5A illustrates another representation of a mapping between topics and bins, where the bins may be listed for each topic are ordered based on degree of correlation (i.e. low to high or high to low).

In some examples, each topic may be structured as a vector or tuple, with each of the elements of the topic vector corresponding to a probability distribution of the topic over a particular bin.

At action 308, the computing device maps between topics and the customers. This may be performed by extracting purchase information corresponding to the customers from the transaction history data structure. For each customer, a number of times that the customer has purchased items corresponding to a category bin may be determined. For example, the category and amount corresponding to each purchase by the customer may be matched to the bins to identify matches. For each customer, a shopping history vector or tuple may be created that represents the number of times that the customer has purchased items corresponding to each bin, with each element of the vector corresponding to a particular bin.

For example, the shopping history vector may be represented as:

S=(S₁, S₂, . . . , S_{N}); (4)

where Sⱼ represents the number of times that the customer S has bought items corresponding to the jth bin, and N represents the total number of bins.

In the present example, the topic vector is computed for the customer, where each element of the vector represents a probability that the customer belongs to a particular topic. For example, for a particular topic entry i in the topic vector v for a customer, the topic entry i may be determined according to the following formula:

vᵢ=Σⱼ₌₁^{N} Sⱼβ_{i,j} (5)

where N is the total number of bins, j is the particular bin, Sⱼ is input based on the determined shopping vector, above, and β_{i,j} is input based on the determined topic—bin matrix.

After computing the topic vector v for a customer, the topic vector may be normalized according to the following formula:

$$v ← \frac{v}{{Σ}_{i = 1}^{N} {v}_{i}} \qquad ( 6 )$$

An example of a database table data structure that includes the customers as rows of the database table and the topics as columns of the database table is described with respect to FIG. 6.

At action 310, customers may be classified based on the customer vectors for segmentation of the customers, cluster analysis, credit risk scoring, and so forth. For example, a supervised learning algorithm may be used to determine a hyperplane in K-dimensional topic space that classifies the customers into different classifications, where K is the number of topics. For example, customer vectors that include particular topic entries that are above or below particular thresholds may be determined to have particular credit risk, based on correlating the customer vectors to credit risk data from credit bureaus.

In addition, an amount of entropy may be determined corresponding to the customer vectors, such that parameters such as number of bins, topics, and so forth may be adjusted to reduce the entropy and increase correlation between the customer vectors and the classifications.

FIG. 4 illustrates a data structure 400 for associating payment amount ranges with a bin, in accordance with various examples of the present disclosure.

The data structure 400 may be structured to include a two-dimensional array, database table, and/or other data structure. In some examples, the data structure 400 includes a database table that includes a row for each bin of a category, where the first entry in the row identifies the bin, and the second entry in the row identifies a payment amount range corresponding to the bin. In another example, the data structure 400 may be structured as a two-dimensional array that includes a first dimension corresponding to a bin of a particular category and a second dimension corresponding to a payment amount range.

In the present example, five example bins (402, 406, 410, 414, and 418) are illustrated corresponding to an “Electronics” category. As illustrated, the first bin 402 corresponds to a first payment amount range 404, which includes the payment amount range from 0.0 to 0.2. The payment amount ranges 408, 412, 416, and 420 correspond to the bins 406, 410, 414, and 418, respectively.

Accordingly, the data structure 400 may be used to match purchased items within the “Electronics” category to bins, such that the purchased items are distributed within the bins based on payment amount. In the present example, the payment amount ranges are normalized, such that 0.0-0.2 represents the items that are associated with a payment amount in the bottom 20% of the category, the 0.2-0.4 represents the items that are associated with a payment amount that is in a next highest 20% payment amount grouping of the category, and so forth.

FIGS. 5A and 5B illustrate data structures for mapping topics to bins, in accordance with various examples of the present disclosure.

The data structures illustrated in FIGS. 5A and 5B may be structured to include arrays, database tables, and/or other data structures. These data structures represent mappings between topics and bins of the categories.

With respect to FIG. 5A, a first data structure 502 and a second data structure 504 are illustrated. Each data structure may be structured as a database table, array, or other suitable data structure. Data structure 502 corresponds to a first topic, “Topic1.” Data structure 504 corresponds to a second topic, “Topic2.” Each topic is associated with bins that are assigned to rows. For example, the first topic includes bins assigned to various price ranges of the books, cellphones, software, electronics, computers, and tickets categories. In more detail, for example, the books$21 bin may correspond to the 21st bin of the books category, such that the bin represents book purchases that are more expensive than the bins of the books category between 1 and 20, but less expensive than books that are assigned to bins of the books category that are higher than 21.

FIG. 5B represents a mapping of bins 506 and topics 508. In the present example, the bins 506 correspond to the columns, and the topics 508 correspond to the rows. For example, the first column is the probability distributions corresponding to the “accounting$07” bin. For example, the first row is the probability distributions corresponding to the topic “3.”

In this example, the data structure is illustrated as a matrix, which may be structured as a two-dimensional array, database table, or other data structure. In each topic row, a probability distribution is provided for the particular topic over the bins 506. For example, with respect to topic “3” the accounting$07 bin represents a 2.993731e⁻¹⁵⁹ probability.

In some examples, each row of the matrix may be referred to as a topic vector or tuple, such that a particular topic vector corresponds to the probability distribution of the bins for the particular topic. In the present example, topic vectors are illustrated for the topics 3-8.

FIG. 6 represents a mapping of customers 602 and topics 604. In the present example, the topics 604 correspond to the columns, and the customers 602 correspond to the rows. For example, the first column is the probability distributions corresponding to topic “4.” For example, the first row is the probability distributions corresponding to the customer “1.”

In this example, the data structure is illustrated as a matrix, which may be structured as a two-dimensional array, database table, or other data structure. In each customer row, a probability distribution is provided for the particular customer over the topics 604. For example, with respect to topic “4,” customer “1” represents a 2.36845Oe⁰⁴ probability.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A data mining system, comprising:
a non-transitory memory storing one or more transaction history data structures; and
one or more hardware processors coupled to the non-transitory memory and configured to read instructions from the non-transitory memory to cause the system to perform operations comprising:
extracting a category of a plurality of categories from the one or more transaction history data structures;
associating a bin of a plurality of bins with the category, the bin corresponding to a payment amount range of the category;
generating a topic vector, the topic vector mapping a topic of a plurality of topics to the plurality of bins, wherein the topic vector includes a bin element indicating probability that the bin corresponds to the topic;
generating a customer vector, the customer vector mapping a customer of a plurality of customers to the plurality of topics, wherein the customer vector includes a topic element indicating probability that the customer corresponds to the topic; and
classifying the customer into at least one classification, the classifying based on the customer vector.

2. The system of claim 1, wherein the topic vector includes at least one element corresponding to each bin of the plurality of bins.

3. The system of claim 1, wherein the customer vector includes at least one element corresponding to each topic of the plurality of topics.

4. The system of claim 2, wherein generating the topic vector includes determining a normalized probability distribution of the plurality of bins for the topic.

5. The system of claim 1, wherein the topic vector is structured as a matrix, wherein a row of the matrix is indexed by the topic, and wherein a column of the matrix is indexed by the bin.

6. The system of claim 3, wherein generating the customer vector includes determining a normalized probability distribution of the plurality of topics for the customer.

7. The system of claim 1, wherein the customer vector is structured as a matrix, wherein a row of the matrix is indexed by the customer, and wherein a column of the matrix is indexed by the topic.

8. The system of claim 6, wherein generating the customer vector further includes determining, for each bin of the plurality of bins, an amount of items purchased by the customer.

9. The system of claim 1, wherein the classification corresponds to a credit risk.

10. A non-transitory machine-readable medium having stored thereon machine-readable instructions executable to cause a machine to perform operations comprising:
extracting a category of a plurality of categories from one or more transaction history data structures;
associating a bin of a plurality of bins with the category, the bin corresponding to a payment amount range of the category;
generating a topic vector, the topic vector mapping a topic of a plurality of topics to the plurality of bins, wherein the topic vector includes a bin element indicating probability that the bin corresponds to the topic;
generating a customer vector, the customer vector mapping a customer of a plurality of customers to the plurality of topics, wherein the customer vector includes a topic element indicating probability that the customer corresponds to the topic; and
classifying the customer, the classifying based on the customer vector.

11. The non-transitory machine-readable medium of claim 10, wherein the topic vector includes at least one element corresponding to each bin of the plurality of bins, and wherein generating the topic vector includes determining a normalized probability distribution of the plurality of bins for the topic.

12. The non-transitory machine-readable medium of claim 10, wherein the topic vector is structured as a matrix, wherein a row of the matrix is indexed by the topic, and wherein a column of the matrix is indexed by the bin.

13. The non-transitory machine-readable medium of claim 10, wherein the customer vector includes at least one element corresponding to each topic of the plurality of topics, and wherein generating the customer vector includes determining a normalized probability distribution of the plurality of topics for the customer.

14. The non-transitory machine-readable medium of claim 10, wherein the customer vector is structured as a matrix, wherein a row of the matrix is indexed by the customer, and wherein a column of the matrix is indexed by the topic.

15. The non-transitory machine-readable medium of claim 13, wherein generating the customer vector further includes determining, for each bin of the plurality of bins, an amount of purchases by the customer.

16. The non-transitory machine-readable medium of claim 10, wherein classifying the customer includes classifying the customer into a credit risk classification.

17. A method for data mining transactions data, the method comprising:
extracting a category of a plurality of categories from one or more transaction records;
associating a bin of a plurality of bins with the category, the bin corresponding to a payment amount range of the category;
generating a topic vector, the topic vector mapping a topic of a plurality of topics to the plurality of bins, wherein the topic vector includes a bin element indicating probability that the bin corresponds to the topic;
generating a customer vector, the customer vector mapping a customer of a plurality of customers to the plurality of topics, wherein the customer vector includes a topic element indicating probability that the customer corresponds to the topic; and
classifying the customer, the classifying based on the customer vector.

18. The method of claim 17, wherein the topic vector includes at least one element corresponding to each bin of the plurality of bins, and wherein generating the topic vector includes determining a normalized probability distribution of the plurality of bins for the topic.

19. The method of claim 17, wherein the customer is classified into a credit risk classification.

20. The method of claim 17, wherein the customer vector includes at least one element corresponding to each topic of the plurality of topics, wherein generating the customer vector includes determining a normalized probability distribution of the plurality of topics for the customer, and wherein generating the customer vector further includes determining, for each bin of the plurality of bins, an amount of purchases by the customer.
